(19) United States
(12) Patent Application Publication
(10) Pub. No.: US 2004/0162112 A1
(43) Pub. Date: Aug. 19, 2004

(54) Portable communication terminal

(75) Inventor: Tsukasa Sato, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/367,704

(22) Filed: Feb. 19, 2003

(51) Int. Cl. H04M 1/00

(52) U.S. Cl. 455/558; 455/550.1

(57) ABSTRACT

When a name card management program as a user's function of a portable telephone set 1 is started, a name card producing function 100 is selected by a menu key (or M key), and a desired name card pattern is read out for producing name card data. The produced name card data is stored in a memory. For name card exchange, the telephone number or mail address of the opposite side terminal is inputted and transmitted by confirming that the own name card data preserved in the memory has been read out and displayed on a display unit. By designating reservation in the presence of display of name card data, which has been received from the opposite side terminal, on the display unit, the received name card data is stored in the memory.

### BACKGROUND OF THE INVENTION

This application claims benefit of Japanese Patent Application No. 2002-040619 filed on Feb. 18, 2002, the contents of which are incorporated by the reference.

The present invention relates to portable communication terminals with name card substitution function, which uses a mobile communication terminal such as a portable telephone set and permits name card exchange via a communication network.

Name cards are usually constituted by paper cards with impression of personal data and fulfill an auxiliary function of communication with their exchange with name cards of others. It is thus indispensable to carry name cards when making a business trip or the like. However, it frequently occurs that the carried name cards are used up due to an extension of the stay period in the destination of the trip. In such an event, impoliteness to the opposite side will be the case.

Also, collected name cards are stocked in an exclusive file or the like, or their data are manually inputted to an electronic diary or the like, so that they are made use of when it becomes necessary to do so. However, with increase of the number of the collected name cards, long time is required for retrieving the file for a necessary name card. Another problem is also posed that inputting name card data by key operation is time-consuming.

As a means for solving the above problems, it has been proposed to make use of a PDA (personal digital assistant) having a communication function or a portable personal computer. In the PDA, it is possible to exchange preliminarily registered name card data with other PDA data and input received data to an address diary of the own system. In the case of utilizing a portable personal computer, it is possible to install PIM (personal information manager) software or the like having a name card exchange function or an address diary management function related thereto for automatic name card data exchange with other communicable systems (as disclosed in, for instance, Japanese Patent Laid-Open No. 2000-307788).

Furthermore, Japanese Patent Laid-Open No. 2001-117883 discloses a portable telephone terminal, in which terminal owner's electronic name card data is preliminarily registered therein to be taken out in an exclusive wireless system in lieu of a paper card name card at the time of name card exchange greeting, while collected name card data management is automatically done therein, thus ensuring the portability of name card data and permitting name card data retrieval at any place without need of carrying any PDA or portable personal computer.

The above disclosed portable telephone terminal comprises application software provided for inputting and recording such name card data as the company name, department, management position, name, address, telephone number, FAX number and electronic mail address of its owner, a memory for storing these data, application software provided for receiving like name card data from the opposite side and permitting the input of memory data related to the name card exchange for managing and recording the data in units of items, and a memory for storing these data. The name card exchange is effected by mutual transmission and reception of the name card data between the two portable telephone terminals in a frequency band free from any trouble in the usual portable telephone system utilization and in a wireless system based on narrow reception area low intensity wireless waves or such light as infrared radiation. The terminal further has a function of permitting the retrieval for the contact destination telephone number or designation of electronic mail destination so as to be able to directly address the destination from it.

The name card exchange which is done by the above disclosed portable telephone terminal, does not require any name card made of paper, thus leaving to the saving of pulp resources. Also, since no name card has to be ordered and purchased, cost reduction can be realized, and also the name card management can be facilitated. Furthermore, with recent wireless spread of portable telephone sets, an advantage is provided that the name card exchange can be made without need of separately carrying any PDA or portable personal computer.

For name card exchange, however, the portable telephone terminal disclosed in the above laid-open publication requires separate provision of a construction for doing wireless communication in a frequency band free from any trouble for utilizing the usual portable telephone system and with weak radio waves of narrow reception area or such light as infrared radiation, and this is a cause of corresponding cost increase of the portable telephone terminal.

### SUMMARY OF THE INVENTION

In view of the above problem, the present invention has an object of providing a means capable of electronic name card exchange by utilizing i mail or fast data communication function provided as movable unit communication function in the portable telephone set.

According to an aspect of the present invention, there is provided a portable communication terminal (foe, example, terminal telephone set) with a name card substitution function, which has a key for inputting data and a display unit for displaying data produced by key input or received data and also has a function of transmitting and receiving data via a network, the portable telephone set comprising: a name card data producing function for producing name card data with key input, a function for storing the produced name card data, a function of presetting a name card exchange mode, a name card data transmitting function that, when the name card exchange mode is preset and data transmission to an other portable telephone set is designated, the data transmitting and receiving function is provided to read out the stored name card data and transmit the read-out data to the other portable telephone set, and a function of name card data received by the data transmitting and receiving function on the display unit.

The above functions are executed according to a name card processing program stored in a memory provided in the portable telephone set. The name card managing program includes such functions as a name card producing function, a function of storing produced name card data, a function of reading out the stored name card data while also displaying and transmitting the read-out data, a function of displaying received name card data while storing the data in a memory and a function of retrieving the stored name card data.

As for the name card producing function, a plurality of name card patterns of different formats are preliminarily stored, and the user can readout a desired name card pattern among the prepared ones and produce a desired name card data piece by key inputting the read-out name card data. The function also includes a function of permitting name card data of a plurality of different patterns to be produced and stored in the memory so as to be able, at a name card exchange time, to select and transmit a desired name card pattern among the plurality of produced patterns.

The mobile communication terminal (foe example, portable telephone set) according to the present invention can realize a function of permitting name card exchange by utilizing i mail or fast data communication provided as a communication function. The name card exchange is thus possible without need of separately providing the portable telephone set with any exclusive hardware for name card exchange and also without need of separately carrying any PDA or personal computer.

Other objects and features will be clarified from the following description with reference to attached drawings.

### BRIEF DESCRIPTION OF THE DRAWINGS

FIG. 1 is a schematic representation of a name card producing function embodying the present invention;

FIG. 2 is a flow chart of processing illustrating the name card exchange function according to the present invention;

FIG. 3 is a flow chart of processing illustrating name card receiving function according to the present invention; and

FIG. 4 is a flow chart of processing illustrating the name card retrieving function according to the present invention.

### PREFERRED EMBODIMENTS OF THE INVENTION

Preferred embodiments of the present invention will now be described with reference to the drawings.

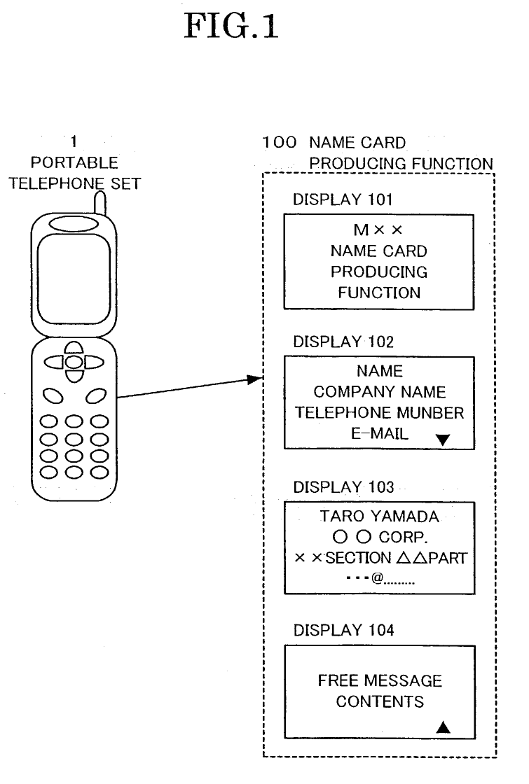

FIG. 1 is a schematic representation of a name card producing function embodying the present invention. A name card managing program for executing the present invention is stored in a memory in a portable telephone set 1.

When the name card management program as a user function of the portable telephone set 1 is started and the name card producing function 100 is selected by a menu key (i.e., M key), a display 101 appears on the display screen (i.e., LCD) of the portable telephone set 1. By depressing determination key after the provision of the display 101, a display 102 appears, and the user then key inputs name card data such as name, company name, telephone number and E-mail address in an entry column (display 103).

The company name, the telephone number and the E-mail address, however, need not be essentially entered, but serve as optional functions. For example, when meeting company-related people, the place of option is of course clearly entered, but this item is unnecessary for people who do company work such as students and housewives.

For this reason, a plurality of name card patterns of different formats are preliminarily prepared and stored as name card producing function of this embodiment, and by designating name card pattern switching in the presence of the display 102, the name card patterns stored in the program are successively switched and displayed. The user thus select adequate name card patterns among the displayed name card patterns.

Also, it is possible to produce a name card having a pattern peculiar to the user by key inputting name card data corresponding to a name card pattern having a horizontal-write format read out as the display 102 and then changing the read-out data to a vertical-write data format or designating the change of the size, the font, etc. of the characters. When no appropriate name card pattern is present among the read-out name card patterns, a name card pattern with arrangement of name card data peculiar to the user can be produced by selecting new name card pattern production in the presence of the display 102.

By producing a desired name card (i.e., display 3) and depressing a certification key, a display 104 appears, in which free message contents can be entered. Then, by entering a free message and depressing a registration key, the produced name card data is registered in the memory in the portable telephone set. The display 104 permits leaving as data contents of talks and prearrangements and also the dates of meeting with the opposite side for transmitting the name card data thereto and, in the case of friends, enjoying the P.R. or the like of the user himself or herself.

The data produced with the function as described above can be preserved up to about 100 cases at the most. When it is desired to leave data forever, it is possible to preserve the data in a personal computer used by the user.

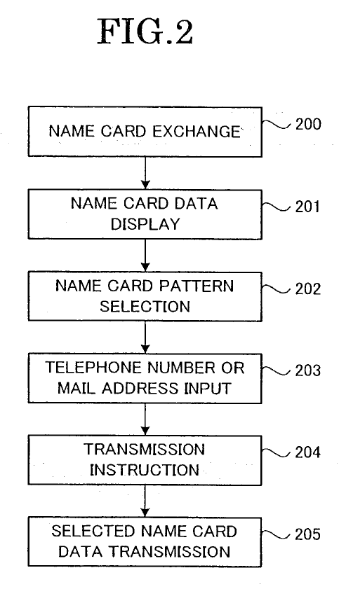

FIG. 2 is a flow chart of processing illustrating the name card exchange function according to the present invention. When the name card exchange function is selected by the M key (Step 200), the own name card data produced by the name card producing function 100 and preserved in the memory is read out and displayed in the display unit (Step 201). In the case of presence of a plurality of different name card patterns registered in the memory, the user prearranges and causes display of the fact that other name card patterns have been registered.

The user then causes successive display of the registered name card patterns and, when a desired name card pattern appears on the display, depresses the certification key (Step 202). Then, the user inputs the telephone number or mail address of the opposite side terminal (Step 203), and depresses a transmit key (Step 204). As a result, the desired name card data and accompanying registered free message are transmitted to the opposite side terminal (Step 205).

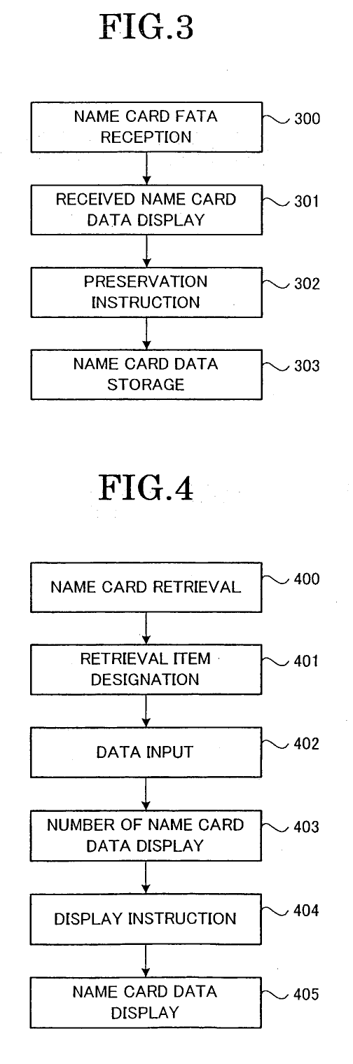

FIG. 3 is a flow chart of processing illustrating name card receiving function according to the present invention. When name card data from the opposite side terminal is received (Step 300), the received name card data is displayed on the display unit (Step 301). By depression of a preserve key in the presence of the name card data display (Step 302), the received name card data is stored in the memory (Step 303).

The name card data stored in the memory can be retrieved for by a name card retrieving function. FIG. 4 is a flow chart of processing illustrating the name card retrieving function according to the present invention. By selecting the name card retrieving function by the M key (Step 400), designating the retrieval items such as name, company name, etc. (Step 401) and key inputting the data (Step 402), the number of pieces of pertinent name card data is displayed on the display unit (Step 403). When the pertinent name card data piece number is too large, it can be reduced by increasing the number of retrieval items.

By depressing a key for designating name card data display in the presence of the pertinent name card data piece number display on the display unit (Step 404), one of the hit name card data ICES is displayed on the display unit (Step405). Subsequently, the other hit name card data pieces are displayed successively one with each depression of the name card data display designation key.

According to the present invention, no name card is necessary, thus leading to the savings of the paper cost and resources. Also, since the widely spread portable telephone functions can be directly utilized, the name card exchange can be realized at a relatively low cost. Furthermore, it is possible to change the name card style as desired. Still further, since the name card data is not of any name card determined by any company, it is possible to readily appeal oneself to the opposite side to provide marriage, and the name card data can be made active use of as a means for maintaining satisfactory condition of communication.

Changes in construction will occur to those skilled in the art and various apparently different modifications and embodiments maybe made without departing from the scope of the present invention. The matter set forth in the foregoing description and accompanying drawings is offered by way of illustration only. It is therefore intended that the foregoing description be regarded as illustrative rather than limiting.

What is claimed is:

1. A portable communication terminal with a name card substitution function, which has a key for inputting data and a display unit for displaying data produced by key input or received data and also has a function of transmitting and receiving data via a network, the portable telephone set comprising:
a name card data producing function for producing name card data with key input, a function for storing the produced name card data, a function of presetting a name card exchange mode, a name card data transmitting function that, when the name card exchange mode is preset and data transmission to an other portable telephone set is designated, the data transmitting and receiving function is provided to read out the stored name card data and transmit the read-out data to the other portable telephone set, and a function of name card data received by the data transmitting and receiving function on the display unit.

2. The portable communication terminal set with a name card substitution function according to claim 1, wherein the name card data producing function includes a function of producing name card data from a selected name card pattern among a plurality of preliminarily prepared name card patterns of different formats and the key inputted name card data.

3. The portable communication terminal with a name card function according to claim 2, wherein the name card data producing function is provided with a free message contents entry column as the name card data.

4. The portable communication terminal with a name card substitution function according to one of claims 2 and 3, wherein the function of storing the produced data includes a function of preserving a plurality of name card data of different formats produced by the name card data producing function.

5. The portable communication terminal with a name card substitution function according to claim 4, wherein the name card data transmitting function of reading out and transmitting selected name card data among a plurality of preserved name card data of different formats produced by the name card data producing function.

6. The portable communication terminal with a name card substitution function according to one of claims 1 to 5, which further comprises a function of storing the received name card data and a function of retrieving and displaying the stored name card data in response to a user's operation.

7. The portable communication terminal with a name card substitution function according to one of claims 1 to 6, which further comprises a function of extracting predetermined data among the received name card data and transferring, for preservation, the extracted data to a telephone diary provided in the portable telephone set.

8. The portable communication terminal with a name card substitution function according to one of claims 1 to 7, wherein the portable communication terminal is a telephone set.
